(19) United States
(12) Patent Application Publication
(10) Pub. No.: US 2011/0247008 A1
(43) Pub. Date: Oct. 6, 2011

(54) SYSTEM AND METHOD FOR FEDERATED SERVICES

(75) Inventor: Chary Tamirisa, Austin, TX (US)

(73) Assignee: DELL PRODUCTS L.P.

(21) Appl. No.: 12/752,893

(22) Filed: Apr. 1, 2010

(51) Int. Cl. G06F 9/46

(52) U.S. Cl. 719/313; 719/330

(57) ABSTRACT

In accordance with the present disclosure, a system and method for federated services. An information handling system comprises a requesting application, a federated service, an enterprise services bus, and an application connector. The requesting application is operable to send at least one application business message. The federated service interfaces with the enterprise services bus. The application connector interfaces with the enterprise services bus and the requesting application. The application connector receives the application business message from the requesting application and transforms it into a business message. The application connector then invokes the federated service based at least in part on the business message. A method of operating a federated service and a software for providing a federated service embodied in a computer-readable medium is disclosed.

### TECHNICAL FIELD

The present disclosure relates generally to the operation of computer systems and information handling systems, and, more particularly, to a system and method for federated services.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include a business service communicatively coupled to an enterprise services bus. An enterprise services bus facilitates loosely coupling applications in a Service Oriented Architecture. Service Oriented Architecture is a relatively new design paradigm for enterprise application integration. A Service Oriented Architecture seeks to increase the reuse of services and applications by allowing loose coupling between applications. This design approach is attractive to users because it allows for improved scalability, and better supports virtualization. In a Service Oriented Architecture, business services define various operations that may be performed on business objects. Business services are application and implementation independent web service definitions of business tasks. Similarly, business objects are application and implementation independent data models used to represent entities such as customers, products, sales orders, invoices, and other entities and objects. A business message is an application and implementation independent message format that is used to carry only the essential data elements needed by a business service to complete an operation. In a Service Oriented Architecture, business messages are used to request and provide services between disparate applications.

### SUMMARY

In accordance with the present disclosure, a system and method for federated services. An information handling system comprises a requesting application, a federated service, an enterprise services bus, and an application connector. The requesting application is operable to send at least one application business message. The federated service interfaces with the enterprise services bus. The application connector interfaces with the enterprise services bus and the requesting application. The application connector receives the application business message from the requesting application and transforms it into a business message. The application connector then invokes the federated service based at least in part on the business message. A method of operating a federated service and a software for providing a federated service embodied in a computer-readable medium is disclosed. The federated service is interfaced to an enterprise services bus. An application connector is interfaced to the enterprise services bus and a requesting application. The application connector receives an application business message from the requesting application, and transforms the message into a business message. The federated service is invoked based at least in part on the business message.

The system and method disclosed herein is technically advantageous because it provides a flexible architecture that allows for easily segregating or aggregating services transparently. A second advantage of the system and method disclosed is that it helps enable cloud computing. A third advantage of the system and method disclosed herein is that it enables creating enterprise-level business services by delegating tasks to regional business services that share a common interface. This allows services to reside in separate domains based on geographic or line of business boundaries. A fourth advantage of the system and method disclosed is that it enables a single business message to be transported across a wide area network and distributed to multiple applications. This increases messaging efficiency when a service is presented to a user that is in one region, and the processing is completed in one or more remote regions. A fifth advantage of the system and method disclosed herein is that a business message can be provided to multiple instances of a given application based on a routing logic. A sixth advantage of the system and method disclosed herein is that it provides improved access to remote databases, or other resources, by delegating resource access to a remote service. This avoids opening and holding connections to the remote resources across a wide area network or separate domains. A seventh advantage of the system and method disclosed herein is that it allows business messages to be batched and/or compressed before the messages are distributed to remote applications. An eighth advantage of the system and method disclosed herein is that allows multiple information handling systems to communicate information in a flexible and efficient manner with location transparency. A ninth advantage of the system and method disclosed herein is that it provides a way to enable federation of services at the application-level. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows a Service Oriented Architecture with a business service.

FIG. 2 shows a Service Oriented Architecture with a federated business service as disclosed herein.

FIG. 3 illustrates a different embodiment of the federated business service as disclosed herein.

FIG. 4 illustrates another embodiment of the federated business service as disclosed herein where the local portion of the federated service invokes the service of local provider application

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

An information handling system may include a business service communicatively coupled to an enterprise services bus in a Service Oriented Architecture. It is frequently useful to separate the information maintained by a system from the information that it may need to exchange with another system. For example, for an itinerary in a travel management application, the system may maintain information about the traveler, the point of origin, the destination, and perhaps a history of changes made to the itinerary, such as the identity of the travel arranger and how the plans changed. However, when the traveler wants to print a copy of their itinerary, only their identity and perhaps the date of travel or destination should be necessary to make the request. Similarly, when two applications need to exchange information, typically only a subset of the information maintained by either system is of interest to the other. Business services and business messages provide a flexible way to describe and implement solutions that take advantage of this concept. Business services define various operations that may be performed on business objects. A business service is an application and implementation independent web service definition of a business task or tasks. For example, a business service for sales orders may define several operations: one operation for creating an order, one operation for deleting an order, and one operation for checking the status of an order. Each of these operations will accept a different type of business message sent by a requesting application through the enterprise services bus.

It is also useful to use canonical models for the business objects and business services. Canonicalization reduces the number of data formats that the business services need to support, and provides a single view of the underlying data objects, such as a sales order or customer. A business object is an application and implementation independent data model used to represent an entity or object such as a customer, a product, a sales order, an invoice, or some other thing. Because business objects are designed to be application and implementation independent, they are typically large in size and contain more information than is needed by a business service to complete its task. To address this issue, business messages are used to send information between applications in a Service Oriented Architecture. A business message is an application and implementation independent message format that is used to carry only the essential data elements needed by a business service to complete an operation. Whenever a business service needs to request service from another application, the application is invoked by sending a business message to the application. The enterprise services bus routes the messages between the various business services and application connectors. The enterprise services bus is responsible for routing business messages and providing a reliable message delivery service. Application connectors interface applications that are not able to directly communicate with other entities on the enterprise services bus. The application connector receives a business message on behalf of the application and transforms the message to a format understandable by the application. This transformed message is referred to as an application business message. The application connector may also function in the opposite direction. For example, the application may request service by creating an application business message. The application connector will then convert the request into a business message and forward the message to the enterprise services bus.

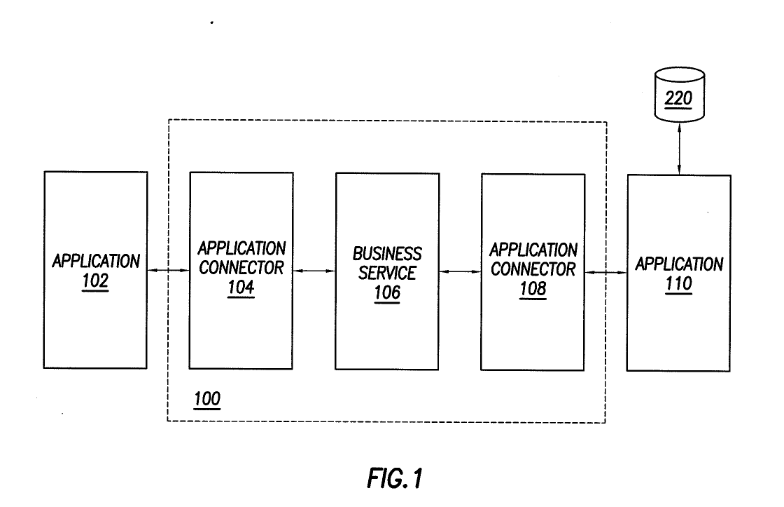

The operation of a Service Oriented Architecture is described in more detail with reference to FIG. 1. Application connectors 104 and 108 interface requesting application 102 and provider application 110 respectively to the Service Oriented Architecture. The terms requesting application and provider application are merely used to simplify the disclosure herein. There is no requirement that any given application be solely a requesting application or solely a provider application. In practice, applications likely will function both as requesting applications and as provider applications in different transactions. Each application connector is able to send and receive business messages using the enterprise services bus 100 to other components of the Service Oriented Architecture, such as business service 106. Furthermore, each application connector is able to communicate with its associated application using messages. The messages may be in a format specific to the application. Messages exchanged between the application connector and an application are typically referred to as application business messages to distinguish them from business messages, which are usually in a different format. Application connectors may also perform message validation. An application connector can exchange messages with its associated application using any number of methods depending upon the interfaces and methods provided by the associated application. For example, messages may be exchanged using flat files, web service calls, remote procedure calls, or message queues. Application connectors are typically developed from the ground up to interface the associated application with the Service Oriented Architecture. In FIG. 1, requesting application 102 is communicatively coupled to application connector 104. Application connector 104 receives an application business message (ABM) from requesting application 102 and transforms the message into a business message (BM). Application connector 104 then provides the message to the enterprise services bus 100 which routes the BM to business service (BS) 106. Business service 106 processes the BM and determines which provider applications need to receive the message. A business message is prepared for the provider application by the business service 106 and is handed over to the enterprise services bus 100 which handles routing the message to application connector 108. Application connector 108 transforms the BM into an application business message understood by provider application 110 and provides the message using an interface to the application. Provider application 110 completes the processing of the message, which may involve accessing other resources outside of the Service Oriented Architecture, such as updating a database 220. If provider application 110 generates a response, such as an acknowledgment, application connector 108 may transform the message into an appropriate business message so that it can be sent back to the calling business service 106. It should be noted that this system is capable of both synchronous and asynchronous operation. For example, in a synchronous operation, the requesting application 102 will wait for a response or acknowledgment to be returned from the business service before it handles any other tasks. In an asynchronous operation, the requesting application 102 sends its application business message, and continues processing without waiting for any sort of response from the provider application or applications.

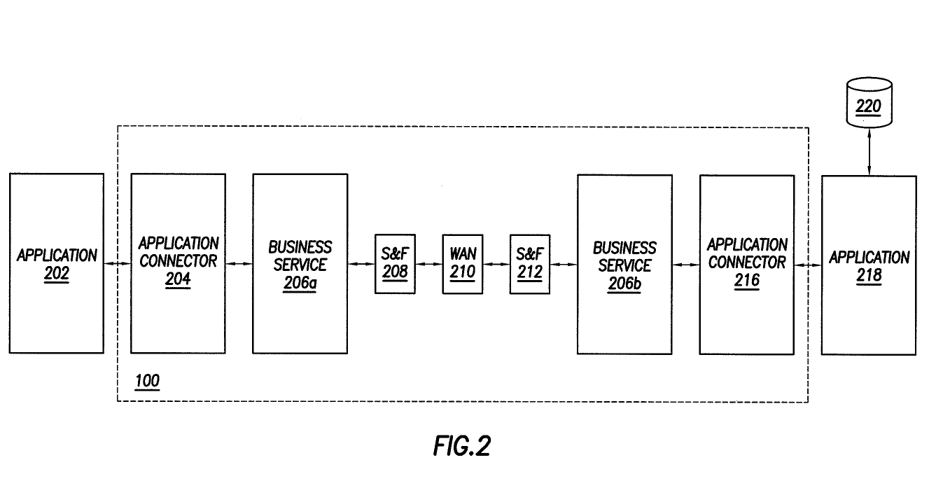

Shown in FIG. 2 is a federated business service as disclosed herein. In this figure, requesting application 202 prepares an application business message which is provided to application connector 204. Application connector 204 transforms the received message into a business message, and hands off the message to the enterprise services bus 100. In this figure, federated business service 206 has two portions, federated business service 206a, which is local to application connector 204, and federated business service 206b, which is the portion remote to application connector 204. It is important to note that the terms remote and local can not only refer to geographic proximity, but may also refer to logical proximity. For example, two objects may be located in close physical proximity, but may reside in different computing domains. Enterprise services bus 100 routes the message to the federated business service 206a. When business service 206a receives the business message, instead of directly invoking other applications across the enterprise services bus, business service 206a invokes business service 206b to finish servicing the message. As a result, only a single message has to pass across the wide area network (WAN) 210 to reach the business service 206b and application connector 216. Store and forward agents 208 and 212 may handle moving the message across the WAN connection 210. The store and forward agents 208 and 212 may batch messages, compress messages, or do both to better utilize the WAN connection 210 that connections both halves of the federated business service 206. In another embodiment, a queue may be used to move messages across the WAN connection 210. Once the business message reaches business service 206b, the message is processed normally. Accordingly, the message is routed by enterprise services bus 100 to application connector 216. Application connector 216 then transforms the message into an application business message that can be consumed by provider application 218. Provider application 218 processes the message, and may interface with other resources, such as database 220, to complete its task.

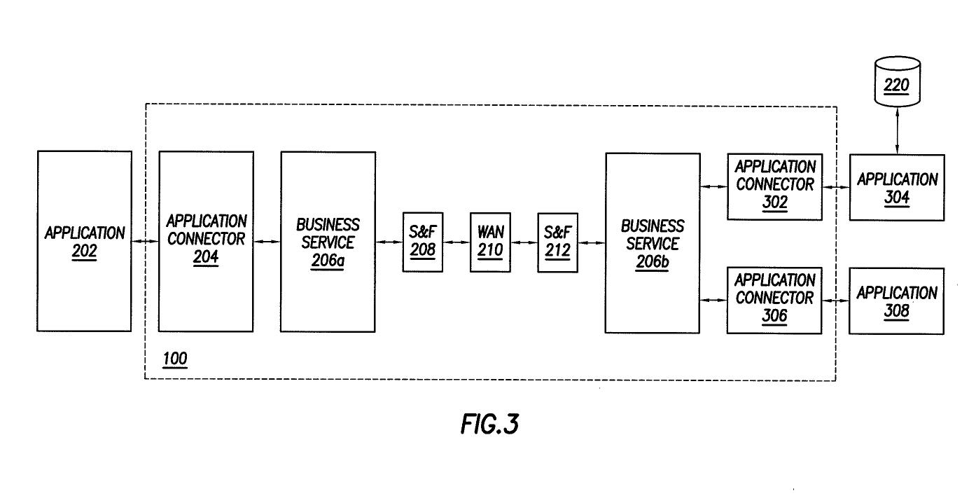

FIG. 3 illustrates a different embodiment of the federated business service disclosed herein. In this figure, federated business service 206 is invoked by application 202. Federated business service 206a first receives the message from the requesting application 202 via application connector 204 and enterprise services bus 100. Federated service 206a then passes the message to federated service 206b. Federated service 206b then may send a message to more than one provider application, such as provider applications 304 and 308 using application connectors 302 and 306. Provider applications 304 and 308 may in turn connect to other resources, such as database 220, to complete the processing of the message it received the federated service 206. Although this figure only shows two applications, any number of applications can be invoked by the business service. Furthermore, a message need not be delivered to a given provider application once. For example, provider application 308 may only be a different instance of provider application 304.

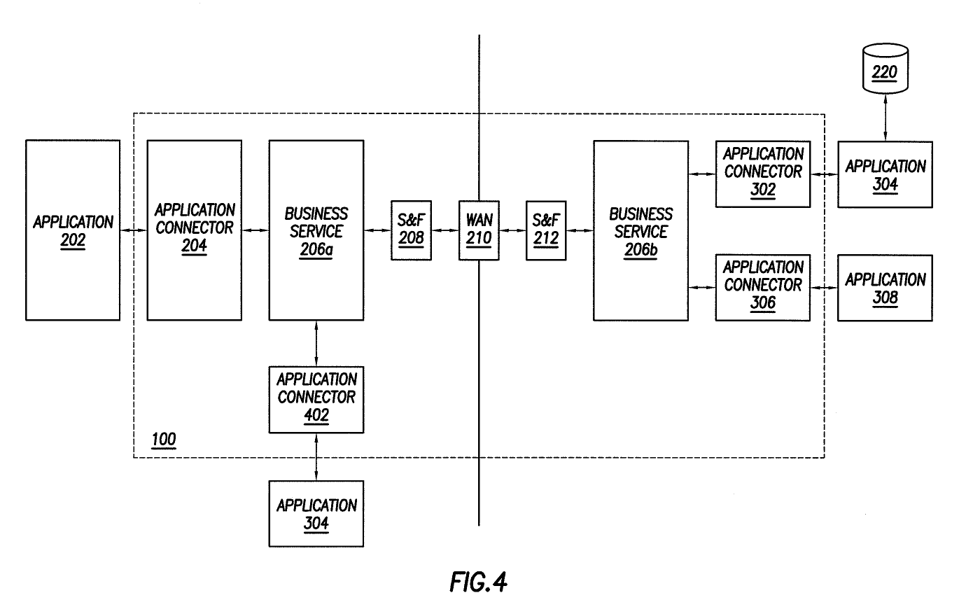

FIG. 4 illustrates another embodiment of the federated service disclosed herein where the local portion of the federated service invokes the service of local provider application. In this figure, when federated business service 206a receives a business message from application connector 204, business service 206a sends a message to invoke the service of local provider application 404 via application connector 402. Federated business service 206a also sends a message to its remote portion, business service 206b, which in turn invokes provider applications 304 and 308 as previously described.

Although the present disclosure has been described in detail, it should be understood that various changes, substitutions, and alterations can be made hereto without departing from the spirit and the scope of the invention as defined by the appended claims.

What is claimed is:

1. An information handling system comprising:
a requesting application operable to send at least one application business message;
a federated service operable to interface with an enterprise services bus; and
an application connector operable to:
interface with the enterprise services bus and the requesting application;
receive the at least one application business message;
transform the at least one application business message into at least one business message; and
invoke the federated service, wherein the federated service is invoked based at least in part on the business message.

2. The system of claim 1, wherein:
the federated service comprises at least one local service and at least one remote service;
the local service is operable to receive the business message from the application connector; and
the local service is operable to invoke the remote service.

3. The system of claim 2, wherein the remote service invokes the provider application.

4. The system of claim 3, wherein the provider application updates a resource.

5. The system of claim 3, wherein the remote service invokes more than one instance of the provider application.

6. The system of claim 2, wherein a store and forward agent receives the business message from the local service and sends the business message to the remote service.

7. The system of claim 6, wherein the store and forward agent is operable to batch business messages for sending to the remote service.

8. Software for providing a federated service, the software being embodied in a computer-readable medium and when executed operable to:
interface a federated service to an enterprise services bus;
interface an application connector to the enterprise services bus and a requesting application;
receive at the application connector at least one application business message from the requesting application;
transform the at least one application business message into at least one business message; and
invoke the federated service based at least in part on the business message.

9. The software of claim 8, further operable to:
receive at a local service the business message from the application connector; and
invoke at least one remote service by the local service;
wherein the federated service comprises the at least one local service and the at least one remote service.

10. The software of claim 9, wherein the at least one remote service invokes at least one provider application.

11. The software of claim 10, wherein the at least one provider application updates a resource.

12. The software of claim 10, wherein the at least one remote service invokes more than one instance of the provider application.

13. The software of claim 9, wherein a store and forward agent receives the business message from the local service and sends the business message to the remote service.

14. The software of claim 13, wherein the store and forward agent is operable to batch business messages for sending to the remote service.

15. A method of operating a federated service comprising:
interfacing a federated service to an enterprise services bus;
interfacing an application connector to the enterprise services bus and a requesting application;
receiving at the application connector at least one application business message from the requesting application;
transforming the at least one application business message into at least one business message; and
invoking the federated service based at least in part on the business message.

16. The method of claim 15, comprising:
receiving at a local service the business message from the application connector; and
invoking at least one remote service by the local service;
wherein the federated service comprises the at least one local service and the at least one remote service.

17. The method of claim 16, wherein the at least one remote service invokes at least one provider application.

18. The method of claim 17, wherein the at least one provider application updates a resource.

19. The method of claim 17, wherein the at least one remote service invokes more than one instance of the provider application.

20. The method of claim 16, wherein a store and forward agent receives the business message from the local service and sends the business message to the remote service.
